(19) United States
(12) Patent Application Publication
(10) Pub. No.: US 2026/0194351 A1
(43) Pub. Date: Jul. 9, 2026

(54) Micromachined inertial angular sensor

(71) Applicant: THALES, Meudon (FR)

(72) Inventor: Nicolas Jean-Marc Frédéric VERCIER, VALENCE (FR)

(21) Appl. No.: 19/130,544

(22) PCT Filed: Nov. 23, 2023
(86) PCT No.: PCT/EP2023/082803

§ 371 Date: May 15, 2025

(30) Foreign Application Priority Data
Nov. 24, 2022 (FR) FR2212250

(51) Int. Cl. G01C 19/5712

(52) U.S. Cl. CPC G01C 19/5712

(57) ABSTRACT

A micromachined inertial angular sensor including a support member having a first axis in a support plane and a second axis perpendicular to the first axis and included in the support plane. The angular sensor further includes at least one vibrating mass, which is movable relative to the support member, at least one electrostatic adjustment transducer, which is configured to apply an adjustable electrostatic strength to the vibrating mass, the or each electrostatic adjustment transducer including at least two rows of teeth forming a pair of combs. The angular sensor further includes at least one intermediate structure which is elongate in at least one extension direction, the intermediate structure projecting from an attachment edge of the vibrating mass or the support member, and supporting one of the rows of teeth.

### CROSS-REFERENCE TO RELATED APPLICATIONS

This application claims benefit under 35 USC § 371 of PCT Application No. PCT/EP2023/082803 entitled MICROMACHINED INERTIAL ANGULAR SENSOR, filed on Nov. 23, 2023 by inventor Nicolas Jean-Marc Frédéric Vercier. PCT Application No. PCT/EP2023/082803 claims priority of French Patent Application No. 22 12250, filed on Nov. 24, 2022.

### FIELD OF THE INVENTION

The present invention relates to a micromachined inertial angular sensor The invention relates to the field of inertial angular sensors for on-board use. Such sensors are used, for example, for navigation, piloting, guidance, or course finding.

### BACKGROUND OF THE INVENTION

Inertial angular sensors are configured to measure angular position, and are generally referred to as gyroscopes in this case. In another case, the angular sensors are configured to measure angular velocity, in which case they are called gyrometers.

Micromachined inertial angular sensors, also known as MEMS inertial sensors, are known per se, for example from EP 2 960 625 A1.

Such a sensor generally comprises one or more masses which are excited to vibrate in a plane formed by mutually perpendicular X and Y axes. This plane is perpendicular to a Z-axis which forms a so-called sensitive axis of the sensor. When the sensor is rotated about its sensitive axis, a combination of the vibration of the moving mass(es) with an angular rotation vector generates forces due to the Coriolis effect, which cause the moving masses to vibrate naturally perpendicular to the excitation vibration and the sensitive axis. The amplitude of this natural vibration is proportional to the speed of rotation of the sensor and allows a value of the angular velocity around the sensitive axis to be deduced.

Inertial angular sensors, for example, have mechanical deviations due to manufacturing tolerances. To improve the measurement accuracy of such sensors, it is possible to provide adjustment actuators to compensate or balance these mechanical deviations, for example deviations in the mass or shape of the sensor or certain parts of the sensor.

In one example, mechanical deviations or defects in the micromachined sensor introduce a quadrature bias. The quadrature bias corresponds to a coupling of strengths acting on a vibrating mass of the micromachined sensor along two perpendicular axes. To compensate for this quadrature bias, one or more electrostatic transducer(s) must be provided, which apply a force to compensate for the quadrature bias. However, such adjustment transducers often take up a lot of space on the surface of the micromachined sensor. Also, an increase in the force applied by these electrostatic transducers often implies an increase in the size of these transducers.

Given the limited surface area of the micromachined inertial angular sensor, it is then difficult to provide electrostatic transducers, particularly for quadrature bias compensation, that have a high applicable force for compensation.

### SUMMARY OF THE DESCRIPTION

One aim of the present invention is to overcome the aforementioned disadvantages.

Thus, one object of the present invention is to obtain a micromachined inertial angular sensor that allows for compensating mechanical deviations, even in the presence of a strong bias, while being of reduced size.

To this end, the object of the invention is a micromachined inertial angular sensor comprising a support member having a first axis in a support plane and a second axis perpendicular to the first axis and comprised in said support plane, the angular sensor further comprising at least one vibrating mass movable relative to the support member, at least one excitation transducer configured to generate a vibrating movement of the vibrating mass, and at least one transducer for detecting a vibration of the vibrating mass.

The angular sensor comprises at least one electrostatic adjustment transducer configured to apply an adjustable electrostatic strength to the vibrating mass, the or each electrostatic adjustment transducer comprising at least two rows of teeth forming a pair of combs.

The angular sensor further comprises at least one intermediate structure which is elongate in at least one extension direction, the intermediate structure projecting from an attachment edge of the vibrating mass or the support member, and supporting one of the rows of teeth. The or each intermediate structure comprises a plurality of sections extending in respective directions in a plane parallel to the support plane or coincident with the support plane, the extension directions of two consecutive sections preferably being at right angles to each other.

The angular sensor comprising at least one elongated intermediate structure increases the surface area, or edge length available for arranging rows of teeth within the sensor, without increasing the total surface area required by the electrostatic adjustment transducer(s). Instead of arranging the rows of teeth of the transducer(s), for example, directly on an attachment edge of the vibrating mass or the support member, the rows of teeth are carried by the elongated intermediate structure, which has an increased surface area for attaching these rows of teeth.

Thus, thanks to the angular sensor according to the invention, rows of teeth with a high number of teeth in particular are arranged on the elongate intermediate structure. As a result, the force applied by the adjustment transducer is increased, without increasing the surface area occupied by the transducer.

In other beneficial aspects of the invention, the angular sensor comprises one or more of the following features, taken in isolation or in any technically possible combination:
each row of teeth comprises a plurality of teeth extending parallel to one another, each tooth of the row of teeth carried by the intermediate structure projecting from said intermediate structure, preferably projecting from said intermediate structure in a direction perpendicular to the extension direction of the intermediate structure;
the or each adjustment transducer is an electrostatic transducer for compensating a quadrature bias, configured to modify the distribution of strengths acting on the vibrating mass, the quadrature bias corresponding to a coupling of the strengths acting on the vibrating mass along the first axis and the second axis;
the extension direction of the or each intermediate structure forms an angle with the attachment edge of between 45 and 90 degrees;
the angle is substantially equal to 90 degrees;
the angular sensor comprises a plurality of intermediate structures parallel to one another;
the two rows of teeth comprise a first row of teeth integral with the vibrating mass and a second row of teeth integral with the support member, the intermediate structure projecting from the attachment edge of the vibrating mass, referred to as the movable edge, when it carries the first row of teeth, the intermediate structure projecting from the attachment edge of the support member, referred to as the fixed edge, when it carries the second row of teeth;
the angular sensor comprises both at least one intermediate structure projecting from the movable edge and carrying the first row of teeth, and at least one intermediate structure projecting from the fixed edge and carrying the second row of teeth;
the or each intermediate structure comprises a plurality of sections extending in respective directions in a plane parallel to the support plane or coincident with the support plane;
the extension directions of two consecutive sections are at right angles to each other;
the or each intermediate structure and at least one of said rows of teeth form a fractal structure, wherein said row of teeth is provided with a row of secondary teeth, projecting from teeth of said row of teeth;
at least the or each intermediate structure and the row of teeth carried by said intermediate structure are formed in a single piece;
the angular sensor comprises at least two vibrating masses movable relative to the support member and movable relative to each other, suspended by suspension springs from fixed anchoring points on the support member and coupled together by coupling springs to vibrate in phase opposition.

### BRIEF DESCRIPTION OF THE DRAWINGS

These characteristics and advantages of the invention will become apparent upon reading the following description, which is given solely by way of a non-limiting example, with reference to the attached drawings, in which:

FIG. 1 is a schematic view of an example inertial angular sensor according to the invention;

FIG. 2 is a schematic view of an example of a part of the angular sensor of FIG. 1 comprising intermediate structures and adjustment transducers according to the invention;

FIG. 3 is a schematic view analogous to FIG. 2 according to another example of the invention;

FIG. 4 is a schematic view analogous to FIGS. 2 and 3 according to another example of the invention;

FIG. 5 is a schematic view analogous to FIGS. 2 to 4 according to another example of the invention.

### DETAILED DESCRIPTION OF EMBODIMENTS

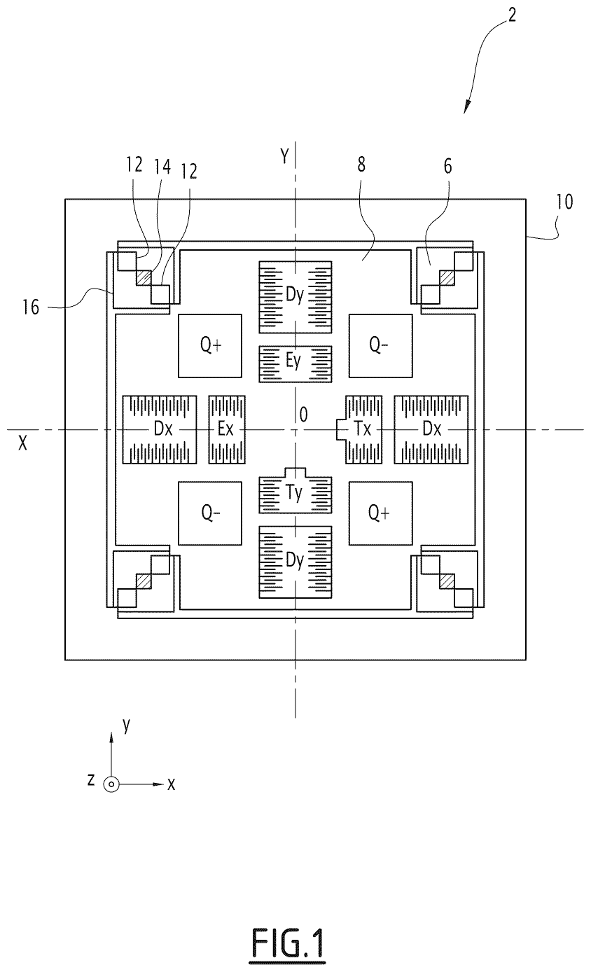

With reference to FIG. 1, the angular sensor 2 comprises a support member 6 extending in a support plane, along a first axis X and a second axis Y perpendicular to the first axis X.

Hereafter, the micromachined inertial angular sensor 2 is referred to as the angular sensor 2.

The angular sensor 2 is for example a gyrometer that is configured to measure an angular velocity. Alternatively or additionally, the angular sensor 2 is a gyroscope for measuring an angular position.

The angular sensor 2 is a micromachined sensor, and thus forms a microelectromechanical system, also defined by its acronym MEMS.

In particular, the angular sensor 2 is a sensor intended to be carried in a vehicle, not shown, for example in an aircraft, a drone or a ship.

The angular sensor 2 is for example intended for use in a vehicle navigation, steering, or guidance system.

The angular sensor comprises at least one vibrating mass.

With reference to FIG. 1, the angular sensor 2 comprises, for instance, two vibrating masses 8, 10, arranged around each other, to form a so-called inner mass 8 and outer mass 10.

The angular sensor 2 is in particular a tuning fork gyro, particularly a tuning fork gyro with two vibrating masses.

“Vibrating mass” means that the or each mass 8, 10 is capable of oscillating, for example driven by means described below, and by the Coriolis effect when the angular sensor 2 is rotated.

Each vibrating mass 8, 10 is movable relative to the support member 6.

In the case of two vibrating masses 8, 10, the vibrating masses 8, 10 are preferably also movable relative to each other. In particular, the centres of gravity 0 of the vibrating masses 8, 10 coincide when at rest.

The angular sensor 2 further comprises, for instance, suspension springs 12, for example four for each vibrating mass 8, 10, suspending each vibrating mass 8, 10 from a respective anchor point 14 which is fixed relative to the support member 6.

The angular sensor 2 further comprises, for instance, coupling springs 16, for example four when the angular sensor 2 comprises two masses 8, 10, coupling the vibrating masses 8, 10 to each other to allow vibration of the masses 8, 10 in phase opposition.

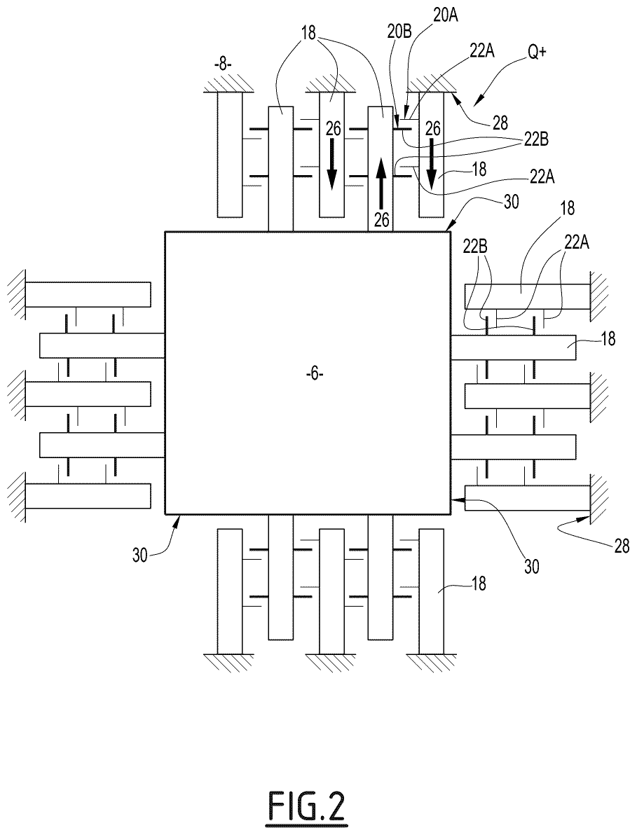

With reference to FIGS. 2 to 5, the angular sensor 2 comprises at least one intermediate structure 18 projecting from the vibrating mass 8, 10 or the support member 6. The examples in FIGS. 2 to 5 show intermediate structures 18 projecting from the vibrating mass 8 and intermediate structures 18 projecting from the support member 6. In addition, not shown, the angular sensor 2 further comprises intermediate structures 18 projecting from the vibrating mass 10.

With reference to FIG. 1, the angular sensor 2 further comprises at least one detection transducer Dx, Dy configured to detect a vibration of the vibrating mass 8, 10. Each detection transducer Dx, Dy comprises, for example, at least one comb integral with the vibrating mass 8, 10 and at least one comb integral with the support member 6. In this case, each detection transducer Dx, Dy is thus configured to detect the vibration by measuring variations in load between the combs.

The angular sensor 2 further comprises at least one excitation transducer Ex, Ey configured to generate a vibratory movement of the vibrating mass 8, 10.

The angular sensor 2 further comprises at least one electrostatic adjustment transducer Tx, Ty, Q+, Q−.

In the example shown in FIG. 1, only the detection transducers Dx, Dy, the excitation transducers Ex, Ey and the electrostatic adjustment transducers Tx, Ty, Q+, Q− arranged on the inner mass 8 are shown. Preferably, the angular sensor 2 also comprises detection transducers Dx, Dy, excitation transducers Ex, Ey and/or electrostatic adjustment transducers Tx, Ty, Q+, Q− arranged on the outer mass 10.

For example, each electrostatic adjustment transducer Tx, Ty, Q+, Q− is configured to apply an adjustable electrostatic strength to the vibrating mass 8, 10.

“Adjustable electrostatic strength” means that the corresponding electrostatic adjustment transducer is configured to apply a force to the vibrating mass 8, 10, for example as a function of a received voltage.

In one example, the angular sensor 2 comprises a first type of electrostatic transducer Tx, Ty and a second type of electrostatic transducer Q+, Q−.

The first type of electrostatic adjustment transducer Tx, Ty is configured, for example, to apply an electrostatic strength to compensate for a frequency bias of a tuning fork vibration mode along the first axis X and/or along the second axis Y. In particular, the first type of electrostatic adjustment transducer Tx, Ty is configured to compensate for a difference in vibration frequency between vibrations along the first axis X and the second axis Y.

An example of the first type of electrostatic adjustment transducer Tx, Ty is shown in FIG. 1.

The first type of electrostatic adjustment transducer Tx, Ty comprises, for example, interdigitated teeth, which are in particular either elongate along the first axis X or elongate along the second axis Y.

In particular, the second type of electrostatic adjustment transducer Q+, Q− is configured to compensate for a quadrature bias.

The quadrature bias corresponds to a coupling of one or more strengths acting on the vibrating mass 8, 10, and in particular corresponds to a coupling of the strengths of the suspension springs 12 along the first axis X and the second axis Y. For example, the quadrature bias is due to manufacturing differences in the suspension springs 12. An example of the operation of the second type of electrostatic adjustment transducer Q+, Q− is described in EP 2 960 625 A1.

In particular, the second type of electrostatic adjustment transducer Q+, Q− is configured to modify the distribution of the strength(s) acting on the vibrating mass 8, 10, in particular so as to align the main axes of dynamic strength on the first axis X and the second axis Y. In particular, by adjusting the electrostatic strengths applied to the vibrating mass 8, 10, the second type of electrostatic adjustment transducer Q+, Q− is configured to compensate for the quadrature bias, for example caused by manufacturing tolerances of the angular sensor 2.

The electrostatic transducer Tx, Ty, Q+, Q− and an example of its arrangement in the angular sensor 2 are described in the following for the electrostatic transducer of the second type Q+, Q−, referred to as electrostatic transducer Q+, Q− in the following. However, a person skilled in the art will understand that the arrangement of the electrostatic transducer Q+, Q− is also applicable to the transducer of the first type Tx, Ty as an alternative.

Examples of the electrostatic adjustment transducer Q+, Q− are shown in FIGS. 2 to 5 showing parts of the angular sensor 2 comprising the electrostatic transducers Q+, Q−.

Each electrostatic transducer Q+, Q− comprises at least two rows of teeth 20A, 20B forming a pair of combs, in particular a pair of interdigitated combs. Each row of teeth 20A, 20B comprises, and is preferably formed by, a plurality of teeth 22A, 22B extending parallel to each other.

“Interdigitated combs” means in particular that the teeth 22A, 22B are parallel to each other, so as to apply or receive an electrostatic force respectively.

At least one of the rows of teeth 20A, 20B is carried by the corresponding intermediate structure 18 of the angular sensor 2.

In particular, each tooth 22A in the row of teeth 20A forms a pair of teeth with a corresponding tooth 22B in the row of teeth 20B. The teeth 22A, 22B of each pair of teeth are arranged substantially parallel to each other, and in particular at a distance less than a minimum distance from other teeth 22A, 22B. In particular, the teeth 22A, 22B of each pair of teeth are configured to apply an electrostatic force relative to each other.

For example, the two rows of teeth 20A, 20B comprise a first row of teeth 20A attached to the vibrating mass 8, 10, and a second row of teeth 20B attached to the support member 6.

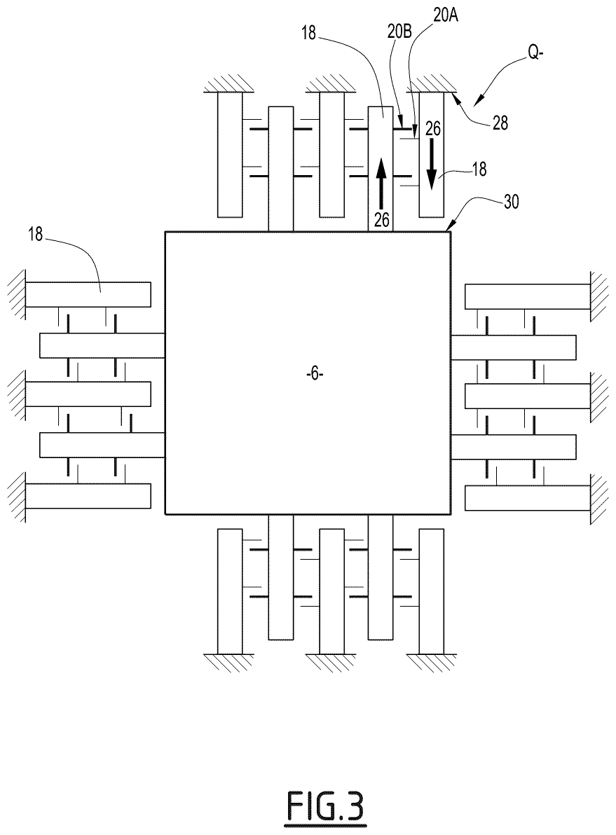

For example, with reference to FIGS. 2 and 3, the teeth 22A are integral with the vibrating mass 8, 10, and the teeth 22B are integral with the support member 6, and are carried by the corresponding intermediate structures 18.

FIG. 2 shows an example of part of the angular sensor 2 comprising intermediate structures 18 carrying rows of teeth 20A, 20B of an electrostatic transducer Q+ forming a positive quadrature bias compensating electrostatic transducer.

“Positive quadrature bias” means in particular that the coupling of the strengths acting on the vibrating mass 8, 10 is a positive value.

Preferably, “positive quadrature bias” means that a movement of the vibrating mass 8, 10 along the second axis Y generates a force along the first axis X which is proportional to and of the same sign as the movement along the second axis Y.

FIG. 3 shows an example of part of the angular sensor 2 comprising intermediate structures 18 carrying rows of teeth 20A, 20B of an electrostatic transducer Q− forming a negative quadrature bias compensating electrostatic transducer.

“Negative quadrature bias” means in particular that the coupling of the strengths acting on the vibrating mass 8, 10 is a negative value.

Preferably, “negative quadrature bias” means that a movement of the vibrating mass 8, 10 along the second axis Y generates a force along the first axis X which is proportional to and of the opposite sign as the movement along the second axis Y.

In the following, the intermediate structure 18 is described in more detail, with reference to FIGS. 2 to 5.

Preferably, the angular sensor 2 comprises a plurality of intermediate structures 18 arranged parallel to one another. Alternatively, the angular sensor 2 comprises a single intermediate structure 18.

Each intermediate structure 18 is elongate along at least one respective extension direction 26.

“Elongate along at least one respective extension direction 26” particularly means that the intermediate structure 18 has a geometric shape with a width perpendicular to the extension direction 26 strictly less than a length of the intermediate structure 18 along the extension direction 26.

For example, the width is strictly less than half the length, preferably strictly less than a third of the length.

In particular, each intermediate structure 18 has a rectangular shape extending in the extension direction 26, with edges parallel to the extension direction 26 having a length strictly greater than edges perpendicular to the extension direction 26.

Each intermediate structure 18 projects from a attachment edge 28 of the vibrating mass 8, 10 or from an attachment edge 30 of the support member 6.

In particular, each intermediate structure 18 projects from the corresponding attachment edge 28, 30 in an extension plane.

The extension plane is parallel to the support plane or coincides with the support plane.

Each attachment edge 28, 30 extends in particular in the plane of extension.

For example, the extension direction 26 of the intermediate structure 18 forms an angle with the attachment edge 28, 30 of between 45° and 90°. Preferably, the angle is substantially equal to 90°, i.e. the intermediate structure 18 projects from the respective attachment edge 28, 30 in a direction perpendicular to said edge 28, 30, in the plane of extension.

Each intermediate structure 18 carries one of the rows of teeth 20A, 20B.

With reference to FIGS. 2 and 3, each tooth 22A in the row of teeth 20A forms a respective pair of teeth with a corresponding tooth 22B in the row of teeth 20B. In the example shown in FIG. 2, following the extension direction 26 of each intermediate structure 18 projecting from the support member 6, each pair of teeth comprises first the tooth 22B carried by this intermediate structure 18, then the tooth 22A carried by the corresponding intermediate structure 18 projecting from the vibrating mass 8. In the example shown in FIG. 3, the arrangement of the teeth 22A, 22B of each pair of teeth is reversed. This order of arrangement of the teeth 22A, 22B of each pair of teeth makes it possible in particular to compensate for the corresponding quadrature bias, i.e. the positive quadrature bias with respect to the example in FIG. 2, and the negative quadrature bias with respect to the example in FIG. 3.

For example, each tooth 22A, 22B projects from the corresponding intermediate structure 18 in a direction perpendicular to the extension direction 26 of that intermediate structure 18. For example, each tooth 22A, 22B extends in a direction parallel to the attachment edge 28, 30, from which the intermediate structure 18 projects. In particular, each tooth 22A, 22B projects from one of the edges of the corresponding intermediate structure 18, which are parallel to the extension direction 26 of that intermediate structure 18.

Preferably, the intermediate structure 18 projects from the attachment edge 28 of the vibrating mass 8, 10, known as the movable edge, when it carries the first row of teeth 20A. In particular, this intermediate structure 18 connects the first row of teeth 20A to the vibrating mass 8, 10.

Even more preferably, the intermediate structure 18 projects from the attachment edge 30 of the support member 6, known as the fixed edge, when it carries the second row of teeth 20B. In particular, this intermediate structure 18 connects the second row of teeth 20B to the support member 6.

In one example, the angular sensor 2 comprises one or more intermediate structures 18 projecting from the movable edge and carrying the first row of teeth 20A, and further comprises one or more intermediate structures 18 projecting from the fixed edge and carrying the second row of teeth 20B.

With reference to FIGS. 2 and 3, the angular sensor 2 comprises, for example, a plurality of intermediate structures 2 projecting with different cross-sections, in particular perpendicular and/or parallel to each other, from the attachment edge 30 of the support member 6 and/or several intermediate structures 2 projecting in different sections, for example perpendicular and/or parallel to each other, from the attachment edge 28 of the corresponding vibrating mass 8, 10.

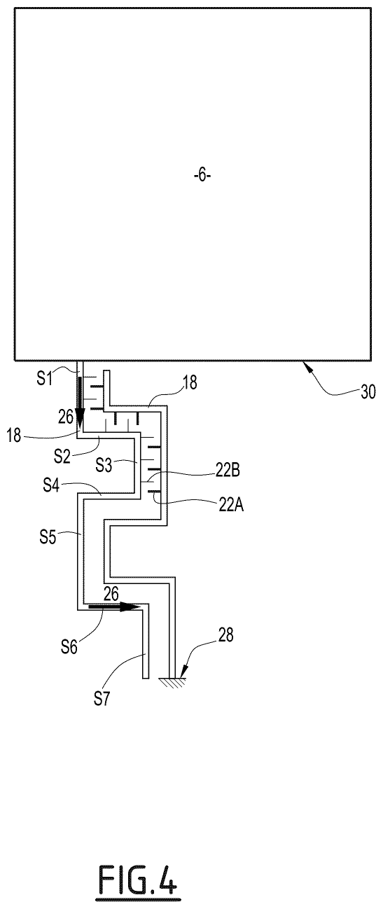

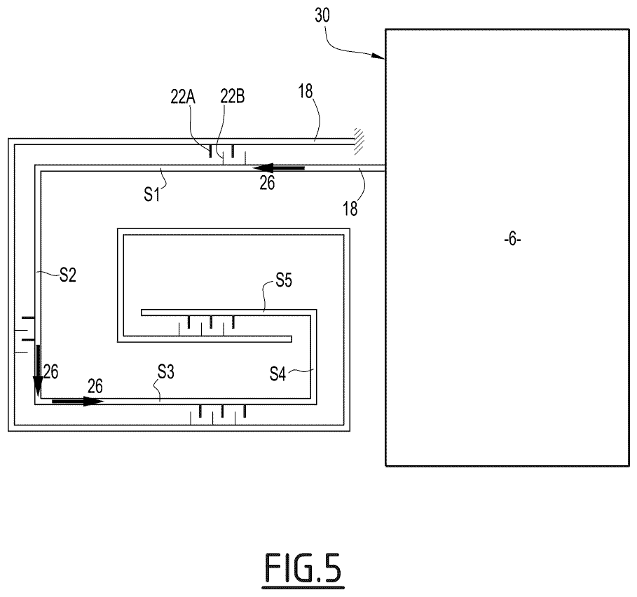

With reference to FIGS. 4 and 5, the or each intermediate structure 18 comprises, for example, a plurality of sections S1, S2, S3, S4, S5, and optionally S6, S7. In this case, each section S1 to S7 extends along a respective extension direction 26, in the extension plane. In particular, the extension directions 26 of two consecutive sections S1 to S7, following the corresponding extension directions 26, present an angle perpendicular to each other.

For example, with reference to FIG. 4, the extension directions 26 of sections S1 to S7 of the or each intermediate structure 18 have the following angles between them, following the extension directions 26 of the intermediate structure 18 projecting from the attachment edge 30 of the support member 6: one angle equal to 90° counter-clockwise between sections S1 and S2, two angles of 90° clockwise between sections S2 and S3 as well as S3 and S4, two angles of 90° counter-clockwise between sections S4 and S5 as well as S5 and S6, and one angle of 90° clockwise between sections S6 and S7.

The teeth 22A are carried by at least two sections S1 to S7, here by sections S1 to S3, and similarly the teeth 22B are carried by at least two sections S1 to S7, here by sections S1 to S3. In this way, the teeth 22A, 22B carried by the same intermediate structure 18 are not all parallel to each other. Advantageously, and not shown, the teeth 22A, 22B extend over each section of the intermediate structure 18 which carries them.

In one example, with reference to FIG. 5, the extension directions 26 of two consecutive sections S1 to S5 are at an angle of 90° to each other in a counter-clockwise direction. In particular, the or each intermediate structure 18 is substantially snail-shaped.

According to an example not shown, the or each intermediate structure 18 and one of the rows of teeth 20A, 20B form a fractal structure.

For example, one of the rows of teeth 20A, 20B is fitted with a secondary row of teeth, not visible in the figures. The secondary row of teeth projects from the teeth 22A, 22B of the row of teeth 20A, 20B provided with this secondary row of teeth. Thus, the teeth 22A, 22B form the intermediate structure for the secondary row of teeth. The secondary teeth carried by the teeth 22A are then configured to apply an electrostatic force to the secondary teeth carried by the teeth 22B, and conversely the secondary teeth carried by the teeth 22B are configured to apply an electrostatic force to the secondary teeth carried by the teeth 22A, in a similar way to that described for the rows of teeth 20A and 20B.

The secondary teeth, being closer together than the primary teeth, are then responsible for the resulting electrostatic forces, with the forces exerted by the primary teeth contributing only marginally to the resulting force.

Advantageously, the arrangement of the secondary teeth is such that the teeth 22A and 22B as well as the secondary teeth are all arranged so as to compensate for positive quadrature bias, or, conversely, so that the teeth 22A and 22B as well as the secondary teeth are all arranged so as to compensate for negative quadrature bias.

Preferably, the secondary row of teeth comprises secondary teeth projecting from the teeth 22A, 22B in a secondary direction perpendicular to a extension direction of the teeth 22A, 22B. In particular, the secondary direction is parallel to the extension direction 26 of the intermediate structure 18 carrying the teeth 22A, 22B. The presence of secondary teeth makes it possible to further increase the number of teeth on the adjustment transducers Q+ and Q− without increasing the surface area occupied by the transducer Q+ or Q−.

Preferably, the intermediate structure 18 and the row of teeth 20A, 20B, which is supported by the intermediate structure 18, are formed from a single piece.

Similarly, in the example where the or each intermediate structure 18 and one of the rows of teeth 20A, 20B form a fractal structure, the intermediate structure 18, the row of teeth 20A, 20B, which is carried by the intermediate structure 18, and the secondary teeth carried by the row of teeth 20A, 20B are formed from a single piece.

For example, when the intermediate structure 18 projects from the attachment edge 28 of the vibrating mass 8, 10, the vibrating mass 8, 10, the intermediate structure 18 and the teeth 22A carried by this intermediate structure 18 are formed from a single piece. In an example in which the intermediate structure 18 is attached to the attachment edge 30 of the support member 6, the support member 6, the intermediate structure 18, and the teeth 22B are formed from a single piece.

For example, elements formed from a single piece are elements obtained by engraving or machining.

According to one example, at least one of the following elements, preferably all of the following elements, comprises silicon or consists of silicon: the support member 6, the intermediate structure 18, the vibrating mass 8, 10, the teeth 22A, 22B of each row of teeth 20A, 20B.

It is clear that the sensor 2 used in this invention has a large number of advantages.

In particular, the sensor 2 according to the invention comprising the intermediate structure(s) 18 makes it possible to increase the space available for the arrangement of a large number of teeth 22A, 22B of each row of teeth 20A, 20B carried by the corresponding intermediate structure 18. Of the large number of variables and modifications that can be made to the sensor 2 to increase the electrostatic strength applicable by the electrostatic adjustment transducer Tx, Ty, Q+, Q− involved, increasing the number of teeth by arranging them on the intermediate structure(s) 18 enables mechanical deviations to be compensated for reliably and effectively. For example, this allows mechanical deviations to be compensated for without increasing the transducer's electrical voltage.

1. A micromachined inertial angular sensor comprising:
a support member comprising:
a first axis in a support plane; and
a second axis perpendicular to said first axis and comprised the support plane;
at least one vibrating mass movable relative to said support member;
at least one excitation transducer configured to generate generating a vibrating movement of said at least one vibrating mass;
and at least one transducer for detecting vibration of said at least one vibrating mass;
at least one electrostatic adjustment transducer applying an adjustable electrostatic strength to said at least one vibrating mass, each electrostatic adjustment transducer comprising at least two rows of teeth forming a pair of combs; and
at least one intermediate structure elongate in at least one extension direction, each intermediate structure projecting from an attachment edge of said at least one vibrating mass or of said support member and carrying one of said rows of teeth, wherein the or each intermediate structure comprises a plurality of sections extending in respective extension directions in a plane parallel to or coincident with the support plane.

2. The angular sensor according to claim 1, wherein each row of teeth comprises a plurality of teeth extending parallel to one another, each tooth of the row of teeth carried by said at least one intermediate structure and projecting from said at least one intermediate structure.

3. The angular sensor according to claim 1, wherein the or each adjustment transducer comprises an electrostatic transducer for compensating a quadrature bias, modifying the distribution of strengths acting on said at least one vibrating mass, the quadrature bias corresponding to a coupling of the strengths acting on said at least one vibrating mass along said first axis and said second axis.

4. The angular sensor according to claim 1, wherein the extension direction of each intermediate structure forms an angle with the attachment edge of between 45 degrees and 90 degrees.

5. The angular sensor according to claim 1, wherein said at least one intermediate structure comprises a plurality of intermediate structures parallel to one another.

6. The angular sensor according to claim 1, wherein said two rows of teeth comprise:
a first row of teeth integral with said at least one vibrating mass; and
a second row of teeth integral with said support member,
wherein said at least one intermediate structure projects from the attachment edge of said at least one vibrating mass, known as the movable edge, when it carries said first row of teeth, and wherein said at least one intermediate structure projects from the attachment edge of the of said support member, known as the fixed edge, when it carries said second row of teeth.

7. The angular sensor according to claim 1, wherein said at least one intermediate structure comprises a plurality of intermediate structures parallel to one another, wherein the two rows of teeth comprise:
a first row of teeth integral with said at least one vibrating mass; and
a second row of teeth integral with said support member, wherein each intermediate structure projects from the attachment edge of said at least one vibrating mass, known as the movable edge, when it carries said first row of teeth, and wherein each intermediate structure projects from the attachment edge of said support member, known as the fixed edge, when it carries said second row of teeth, and wherein said intermediate structures comprise (i) at least one intermediate structure projecting from the movable edge and carrying said first row of teeth, and (ii) at least one intermediate structure projecting from the fixed edge and carrying said second row of teeth.

8. The angular sensor according to claim 1, wherein each intermediate structure and at least one of said rows of teeth form a fractal structure, wherein the at least one of said rows of teeth is provided with a row of secondary teeth, projecting from teeth of the at least one of said rows of teeth.

9. The angular sensor according to claim 1, wherein at least each intermediate structure and the row of teeth carried by that intermediate structure are formed from a single piece.

10. The angular sensor according to claim 1, wherein said at least one vibrating mass comprises at least two vibrating masses movable relative to said support member, and movable relative to each other, suspended by suspension springs from fixed anchoring points on said support member and coupled together by coupling springs to vibrate in phase opposition.

11. There angular sensor according to claim 1, wherein the extension directions of two consecutive sections are perpendicular to each other.

12. The angular sensor according to claim 2, wherein each tooth of the row of teeth carried by the intermediate structure projects from the intermediate structure in a direction perpendicular to the extension direction of the intermediate structure.

13. The angular sensor according to claim 1, wherein the extension direction of each intermediate structure forms an angle with the attachment edge substantially equal to 90 degrees.
